(19) United States
(12) Patent Application Publication
(10) Pub. No.: US 2016/0141600 A1
(43) Pub. Date: May 19, 2016

(54) METHOD OF PRODUCING NEGATIVE ELECTRODE MATERIAL FOR NON-AQUEOUS ELECTROLYTE SECONDARY BATTERY, NEGATIVE ELECTRODE MATERIAL FOR NON-AQUEOUS ELECTROLYTE SECONDARY BATTERY, NEGATIVE ELECTRODE FOR NON-AQUEOUS ELECTROLYTE SECONDARY BATTERY, AND LITHIUM-ION SECONDARY BATTERY

(71) Applicant: SHIN-ETSU CHEMICAL CO., LTD., Tokyo (JP)

(72) Inventors: Masahiro FURUYA, Takasaki (JP); Kohta TAKAHASHI, Takasaki (JP); Hiroki YOSHIKAWA, Takasaki (JP)

(21) Appl. No.: 14/885,579

(22) Filed: Oct. 16, 2015

(30) Foreign Application Priority Data
Nov. 18, 2014 (JP) 2014-233225

(51) Int. Cl. H01M 4/04; H01M 4/1395; H01M 4/587; H01M 4/38; H01M 4/36; H01M 10/0525

(52) U.S. Cl. CPC H01M 4/0471; H01M 4/366; H01M 10/0525; H01M 4/587; H01M 4/386; H01M 4/0428; H01M 4/1395; H01M 2004/027

(57) ABSTRACT

The present invention is a method of producing a negative electrode material for a non-aqueous electrolyte secondary battery, including: preparing silicon-based negative electrode active material particles; and coating each of the prepared particles with a conductive carbon coating by using a rotary kiln while controlling the rotary kiln such that the following relationships (1) and (2) hold true:

W/(376.8×R×T²)≦1.0 (1); and

(T×R²/0.353)≦3.0 (2),
where R is a rotation rate (rpm) of the furnace tube of the rotary kiln, W is a mass (kg/h) of the particles that are put in the furnace tube per hour, and T is an inner diameter (m) of the furnace tube. This method can not only efficiently produce a negative electrode material that is coated with a uniform carbon coating and crystallinity, but also mass-produce negative electrode materials having a high capacity and a high cycle performance.

### BACKGROUND OF THE INVENTION

1. Field of the Invention

The present invention relates to a method of producing a negative electrode material for a non-aqueous electrolyte secondary battery, a negative electrode material for a non-aqueous electrolyte secondary battery produced by this method, a negative electrode for a non-aqueous electrolyte secondary battery containing this negative electrode material, and a lithium-ion secondary battery.

2. Description of the Related Art

As mobile devices such as mobile electronic devices and mobile communication devices have highly developed, secondary batteries with higher energy density are needed to improve efficiency and reduce the size and weight of the devices. The capacity of the secondary batteries of this type can be improved by known methods: use of a negative electrode material made of an oxide of V, Si, B, Zr or Sn, or a complex oxide thereof (See Patent Documents 1 and 2, for example); use of a negative electrode material made of a metal oxide subjected to melting and rapid cooling (See Patent Document 3, for example); use of a negative electrode material made of a silicon oxide (See Patent Document 4 for example); use of a negative electrode material made of Si₂N₂O and Ge₂N₂O (See Patent Document 5 for example), and others. The negative electrode materials can be made conductive by known methods: performing pressure welding of SiO and graphite, and carbonizing the resultant (See Patent Document 6, for example); coating silicon particles with carbon layers by chemical vapor deposition (See Patent Document 7, for example); coating silicon oxide particles with carbon layers by chemical vapor deposition (See Patent Document 8, for example).

Although these conventional methods increase the charging and discharging capacity and energy density to some extent, the increase is insufficient for market needs and the cycle performance fails to fulfill the needs. The conventional methods need to further improve the energy density and thus are not entirely satisfactory.

Patent Document 4 discloses use of a silicon oxide as a negative electrode material for a lithium-ion secondary battery so as to obtain an electrode with a high capacity. To the present inventor's knowledge, however, this method cannot achieve low irreversible capacity at first charging and discharging and a practical level of cycle performance, so this method can be improved on.

The methods to provide a negative electrode active material with conductivity remain the following problems. The method in Patent Document 6 uses solid-state welding and thus cannot uniformly form a carbon coating, resulting in insufficient conductivity. Although the method in Patent Document 7 enables the formation of a uniform carbon coating, this method uses Si as a negative electrode active material and thus reduces the cycle performance because the expansion and contraction of the material becomes too large at lithium insertion or extraction. This makes the material unsuited to practical use. The charging capacity consequently needs to be limited to avoid this problem. Although the method in Patent Document 8 enables the improvement in cycle performance, the material produced by this method lacks the precipitation of silicon fine particles and the conformity with the structure of a carbon coating, and thus is unpractical for use in secondary batteries. This material causes the batteries to gradually reduce the capacity with an increase in charging and discharging cycles and to greatly reduce the capacity after given cycles. In Patent Document 9, a silicon oxide expressed by a general formula of SiOₓ is coated with a carbon coating by chemical vapor deposition to improve the capacity and the cycle performance.

Use of a negative electrode active material coated with a carbon coating such as a graphite coating to give conductivity to this material allows for acquisition of an electrode with a high capacity and good cycle performance. Patent Document 10, for example, proposes mass-production of these negative electrode active materials with a rotary kiln, which is a continuous furnace. As disclosed in Patent Document 10, the rotary kiln has a rotatable furnace tube. Material particles are put in the interior of this furnace tube. Each of these particles can consecutively be coated with a carbon coating while being agitated by heating and rotating the furnace tube.

### CITATION LIST

### Patent Literature

[Patent Document 1] Japanese Patent Application Publication No. H05-174818
[Patent Document 2] Japanese Patent Application Publication No. H06-60867
[Patent Document 3] Japanese Patent Application Publication No. H10-294112

### [Patent Document 4] Japanese Patent No. 2997741

[Patent Document 5] Japanese Patent Application Publication No. H11-102705

### [Patent Document 6] Japanese Patent Application Publication No. 2000-243396

### [Patent Document 7] Japanese Patent Application Publication No. 2000-215887

### [Patent Document 8] Japanese Patent Application Publication No. 2002-42806

### [Patent Document 9] Japanese Patent No. 4171897

### [Patent Document 10] Japanese Patent Application Publication No. 2013-8654

### SUMMARY OF THE INVENTION

Thus, there is a proposition that the rotary kiln is used to coat a negative electrode active material with a conductive carbon coating such as a graphite coating. In a process of coating the negative electrode active material particles with the carbon coating by using the rotary kiln, however, if the bulk of the particles in the interior of the furnace tube becomes excessively large in height, then the amount of contact between a carbon source and each of the particles may vary. In this case, it is difficult to form the carbon coating in a desired amount within a preferred time, resulting in reduction in the productivity.

In addition to this, the furnace tube may be blocked by negative electrode active material particles agglomerated in the interior of the furnace tube. In this case, the formation of the carbon coating cannot be continued. The amount of the carbon coating may differ between a particle in this agglomeration and a agglomeration-free particle, resulting in an uneven amount of the carbon coating in the whole particles. Although the negative electrode active material coated with carbon exhibits excellent performance as a negative electrode active material for a non-aqueous electrolyte secondary battery, there is no efficient method of mass-producing these materials.

The present invention was accomplished in view of the above problems, and it is an object of the present invention to provide a method that not only can efficiently produce a negative electrode material that is coated with a uniform carbon coating and crystallinity for use in a non-aqueous electrolyte secondary battery, but also can mass-produce negative electrode materials for a non-aqueous electrolyte secondary battery having a high capacity and a high cycle performance.

In order to accomplish the above object, the present invention provides a method of producing a negative electrode material for a non-aqueous electrolyte secondary battery, comprising: preparing silicon-based negative electrode active material particles; and coating each of the prepared particles with a conductive carbon coating that is mainly made of carbon by using a rotary kiln having a rotatable furnace tube to perform chemical vapor deposition using a hydrocarbon-based gas on the particles in an interior of the furnace tube while agitating the particles put in the interior of the furnace tube by rotating the furnace tube and controlling the rotary kiln such that the following relationships (1) and (2) hold true:

W/(376.8×R×T²)≦1.0 (1); and

(T×R²/0.353)≦3.0 (2),

where R is a rotation rate (rpm) of the furnace tube of the rotary kiln, W is a mass (kg/h) of the particles that are put in the furnace tube per hour, and T is an inner diameter (m) of the furnace tube.

When the relationship (1) holds true, the bulk of the particles in the interior of the furnace tube can be made proper because the inner diameter T of the furnace tube is sufficiently large with respect to the mass W of the negative electrode active material particles put in the furnace tube per hour. Accordingly, the carbon coating can be formed in a desired amount within a proper time for practical production. In addition to this, the furnace tube can be inhibited from being blocked. When the relationship (2) holds true, the particles tend to move in the furnace tube such that the particles slip down on the inner wall of the furnace tube (a slip-down mode). In this mode, the agglomeration of the particles less frequently occurs compared with a roll-down mode in which the particles roll down on the inner wall of the furnace tube from above. Thus, the carbon coating process performed under the above conditions can inhibit both the generation of agglomeration and variation in the amount of the carbon coating formed on the negative electrode active material particles.

In the method, the inner diameter T (m) of the furnace tube is preferably in the range of 0.1≦T≦3.

When the inner diameter T is 0.1 m or more, a sufficient amount of the particles can be put in the furnace tube, resulting in higher productivity. When the inner diameter T is 3 m or less, the uniformity of a temperature distribution in the interior of the furnace tube can readily be maintained.

Moreover, the furnace tube preferably has a dual structure composed of an outer metal part and an inner carbon part.

The outer metal part inhibits the outer wall of the furnace tube from breaking due to impact. The inner carbon part inhibits the particles from attaching thereto.

The length L (m) of the furnace tube is preferably in the range of 1≦L≦20.

When the length L (m) is 1 m or more, a heating time required for forming the carbon coating can be secured. When the length L (m) is 20 m or less, the distribution of the hydrocarbon-based gas, a carbon source, introduced into the furnace tube can be made more uniform.

The temperature of the interior of the furnace tube is preferably adjusted to the range from 700° C. to 1,300° C.

When the temperature of the interior of the furnace tube is adjusted to 700° C. or more, the carbon coating process can be efficiently performed, and the processing time can be reduced, resulting in good productivity. When the temperature of the interior of the furnace tube is adjusted to 1,300° C. or less, the fusion bonding and agglomeration of each particle can be inhibited during the chemical vapor deposition, so more uniform carbon coating can be formed.

The prepared silicon-based negative electrode active material particles can be SiOₓ particles where 0.5≦x≦1.6.

The negative electrode material for a non-aqueous electrolyte secondary battery preferably contains silicon-based negative electrode active material particles of SiOₓ where x is in the above range. When x is 0.5 or more, SiOₓ particles provide excellent cycle performance when used for a negative electrode of a secondary battery. When x is 1.6 or less, SiOₓ particles provide high charging and discharging capacities when used for a negative electrode of a secondary battery because these SiOₓ particles contain a smaller amount of inactive SiO₂.

Furthermore, the present invention provides a negative electrode material for a non-aqueous electrolyte secondary battery produced by any one of the methods described above, wherein a crystallite size calculated from a half width of a diffraction peak attributable to Si (111) crystal face obtained by X-ray diffraction ranges from 1 nm to 10 nm, and the amount of the carbon coating with which each of the particles is coated ranges from 1 mass % to 30 mass % with respect to the total amount of the particle and the carbon coating.

This silicon-base negative electrode materials coated with the above amount of conductive carbon coating can be stably mass-produced at low cost by using the inventive method of producing a negative electrode material for a non-aqueous electrolyte secondary battery. This negative electrode material for a non-aqueous electrolyte secondary battery exhibits a small variation in first efficiency and excellent cycle performance when used as a negative electrode active material of a secondary battery.

The present invention also provides a negative electrode for a non-aqueous electrolyte secondary battery, comprising: the above negative electrode material; a binder; and a conductive additive.

This negative electrode has a small variation in first efficiency and excellent cycle performance.

The present invention also provides a lithium-ion secondary battery comprising the above negative electrode for a non-aqueous electrolyte secondary battery.

This lithium-ion secondary battery has a small variation in first efficiency and excellent cycle performance.

The inventive method of producing a negative electrode material for a non-aqueous electrolyte secondary battery controls the rotation rate R, the mass W of the particles (the particles to be coated) that are put in the furnace tube per hour, and the inner diameter T of the furnace tube so as to satisfy the relationship (1). The bulk of the particles in the interior of the furnace tube can thereby be made proper because the inner diameter T of the furnace tube is sufficiently large with respect to the mass W of the particles put in the furnace tube per hour. Accordingly, the carbon coating can be formed in a desired amount within a preferred time. In addition to this, the furnace tube can be inhibited from being blocked. The method simultaneously controls the rotation rate R, the mass W of the particles (the particles to be coated) that are put in the furnace tube per hour, and the inner diameter T of the furnace tube so as to satisfy the relationship (2). The movement of the particles in the furnace tube is thereby easy to enter a mode of slipping down on the inner wall of the furnace tube, so the agglomeration of the particles less frequently occurs. In this way, negative electrode materials for a non-aqueous electrolyte secondary battery having a high capacity and a high cycle performance can be mass-produced with a small variation in the amount of the carbon coating.

A negative electrode material for a non-aqueous electrolyte secondary battery produced by the inventive producing method has a high capacity and good cycle performance. A negative electrode using this negative electrode material for a non-aqueous electrolyte secondary battery produced by the inventive producing method and a lithium-ion secondary battery including this negative electrode also have a high capacity and good cycle performance.

### BRIEF DESCRIPTION OF THE DRAWINGS

FIG. 1 is a schematic view showing an exemplary rotary kiln used in a method of producing a negative electrode material for a non-aqueous electrolyte secondary battery according to the present invention;

FIG. 2 is a schematic cross-sectional view of an exemplary furnace tube of the rotary kiln; and

FIG. 3 is a schematic view showing an exemplary configuration of a lithium-ion secondary battery of a laminate film type according to the present invention.

### DETAILED DESCRIPTION OF THE PREFERRED EMBODIMENTS

An embodiment of the present invention will hereinafter be described, but the present invention is not limited to this embodiment.

The present inventors conducted various studies to improve the capacity and cycle performance of a secondary battery and consequently confirmed that battery characteristics can be greatly improved by coating particles made of a material capable of occluding and emitting lithium ions with carbon by pyrolysis of an organic gas. At the same time, the inventors found that mass-production with conventional equipment such as a batch furnace is impractical. In view of this, the inventors considered the possibility of continuous production and consequently found the following: use of a rotary kiln that rotates its furnace tube allows continuous production with a performance level satisfying the market requirement, and both quite excellent quality and productivity can be achieved by controlling production conditions such that the rotation rate R of the furnace tube of the rotary kiln, the mass W of particles to be put per hour, and the inner diameter T of the furnace tube have a given relationship. The inventors thereby brought the invention to completion.

A method of producing a negative electrode material for a non-aqueous electrolyte secondary battery according to the invention will now be described.

The inventive method of producing a negative electrode material for a non-aqueous electrolyte secondary battery mainly includes a preparing process of preparing silicon-based negative electrode active material particles and a carbon coating process of coating each of the prepared particles with a conductive carbon coating that is mainly made of carbon by chemical vapor deposition using a hydrocarbon-based gas.

The preparing process will be first described. In the inventive method of producing a negative electrode material for a non-aqueous electrolyte secondary battery, the silicon-based negative electrode active material particles to be prepared are preferably SiOₓ silicon-based negative electrode active material particles where 0.5≦x≦1.6. When x is 0.5 or more, SiOₓ particles provide excellent cycle performance. When x is 1.6 or less, SiOₓ particles provide high charging and discharging capacities when used for a lithium-ion secondary battery because these SiOₓ particles contain a smaller amount of inactive SiO₂. The value of x preferably satisfies 0.7≦x≦1.3, more preferably 0.8≦x≦1.2.

In this case, the silicon oxide expressed by SiOₓ mainly contains particles having composite structure in which silicon fine particles are dispersed in a silicon compound. All of these particles are preferably expressed by SiOₓ where 0.5≦x≦1.6. These silicon oxide particles have an average diameter preferably ranging from 0.01 μm to 50 μm, more preferably from 0.1 μm to 20 μm, particularly preferably from 0.5 μm to 15 μm, but the invention is not limited to these diameters. It is to be noted that the term “silicon oxide” in the invention is a general term for an amorphous silicon oxide usually obtained by heating a mixture of silicon dioxide and metallic silicon to produce a silicon monoxide gas and cooling and precipitating the silicon monoxide gas.

When the average diameter is 0.01 μm or more, the material is hardly affected by surface oxidation because its surface area is prevented from becoming too large. This allows the material to have a high purity and to maintain high charging and discharging capacities when the material is used as a negative electrode active material for a lithium-ion secondary battery. The bulk density of this material can also be increased, resulting in an increase in charging and discharging capacities per volume. When the average diameter is 50 or less, a slurry obtained by adding a negative electrode active material for a non-aqueous electrolyte secondary battery can readily be applied, for example, to a current collector when an electrode is produced. It is to be noted that the average diameter can be expressed by a volume average particle diameter by particle size distribution measurement using laser diffractometry.

The lower limit of a BET specific surface area of this particle is preferably 0.1 m²/g or more, more preferably 0.2 m²/g or more. The upper limit of the BET specific surface area is preferably 30 m²/g or less, more preferably 20 m²/g or less. This is because the silicon oxide particle having an average diameter and BET specific surface area in the above range is easy to produce with a desired average diameter and BET specific surface area.

In the particles having composite structure in which silicon fine particles are dispersed in a silicon compound, this silicon compound is preferably an inactive compound; more specifically silicon dioxide is preferable because such particles are easy to produce. In addition, these particles preferably have the following properties (i) and (ii).

(i) The silicon fine particles (crystals) preferably has a crystallite size ranging from 1 nm to 50 nm, more preferably from 1 nm to 20 nm, further preferably from 1 nm to 10 nm; this crystallite size is calculated by the Scherrer method on the basis of a spread of a diffraction line in which a diffraction peak that is attributable to Si (111) centered near 2θ=28.4° is observed in X-ray diffraction (Cu-Kα) using copper as a counter negative electrode. When the size of the silicon fine particles is 1 nm or more, the charging and discharging capacities can be kept high. When this size is 50 nm or less, expansion and contraction at charging and discharging are inhibited, and the cycle performance is improved. It is to be noted that the size of the silicon fine particles can also be measured by using photography of transmission electron microscope.

(ii) In measurement of a solid state NMR (²⁹Si-DDMAS), spectrums have a broad peak of silicon dioxide centered near −110 ppm, and a peak of silicon centered near −84 ppm, which is featured as a diamond crystal structure. It is to be noted that these spectrums differ markedly from those of normal silicon oxide (SiOₓ:=1.0+α). Their compositions are clearly different. The silicon crystals dispersed in an amorphous silicon dioxide can be observed by a transmission electron microscope. The amount of silicon fine particles (Si) dispersed in a silicon-silicon dioxide dispersion (Si/SiO₂) preferably ranges from 2 mass % to 36 mass %, more preferably from 10 mass % to 30 mass %. When this amount is 2 mass % or more, the charging and discharging capacities can be kept high. When this amount is 36 mass % or less, good cycle performance can be obtained. A reference substance of a chemical shift in measurement of the solid NMR is hexamethyl cyclotrisiloxane, which is a solid state at the measurement temperature.

It is to be noted that the particle (silicon composite powder) having composite structure in which silicon fine crystals are dispersed in a silicon compound is a particle having a structure in which silicon fine particles are dispersed in a silicon compound. A method of producing this particle is not particularly limited, provided its average diameter ranges from 0.01 μm to 50 μm; the following method can be preferably used.

An example of the preferable method is to perform a heat treatment at temperatures from 900° C. to 1,400° C. under an inert gas atmosphere on silicon oxide powder expressed by a general formula of SiOₓ where 0.5≦x≦1.6, so that these particles disproportionate. All of the particles after the disproportionation are also expressed by SiOₓ where 0.5≦x≦1.6. In the invention, silicon-based negative electrode active material particles subjected to the disproportionation are not necessarily prepared as the particles to be coated with a carbon coating. The disproportionation can be performed at the same time as the carbon coating is formed in the subsequent carbon coating process.

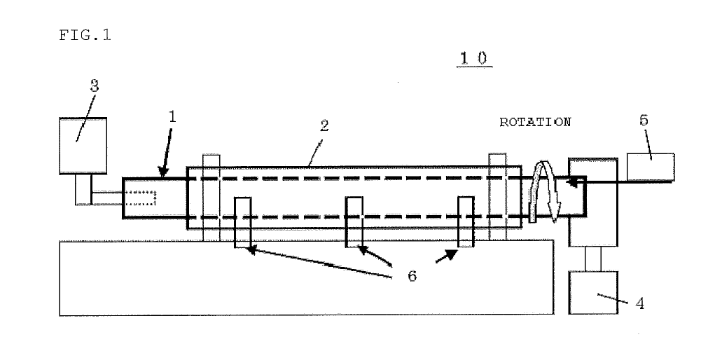

The carbon coating process will next be described. A rotary kiln that can be used in this carbon coating process will now be described with reference to FIG. 1.

As shown in FIG. 1, the rotary kiln 10 mainly includes a furnace tube 1 to coat a raw material, silicon-based negative electrode active material particles, with a carbon coating in its interior, a heating chamber 2 including a heater to heat the furnace tube 1 from the exterior, a feeder 3 capable of continuously introducing the raw material into the furnace tube 1, a container to collect the silicon-based negative electrode active material particles coated with the carbon coating, and a gas supply mechanism 5 to supply a hydrocarbon-based gas that is a raw material of the carbon coating to the interior of the rotary kiln 10.

When each of the particles is coated with the carbon coating by chemical vapor deposition with the rotary kiln 10 configured as above, the furnace tube 1 is heated by the heater provided in the heating chamber 2 while the raw material is continuously put into the furnace tube 1 through the feeder 3 and the furnace tube 1 is rotated about its axis. The furnace tube 1 is disposed so as to incline at a prescribed angle with respect to the horizontal plane. This angle and the rotation of the furnace tube 1 cause the particles to move in the interior of the furnace tube 1. In this way, the particles put in the interior of the furnace tube 1 are agitated and each coated with the carbon coating. The particles coated with the carbon coating are then taken out of the furnace tube 1.

During this process in the invention, each of the particles is coated with the carbon coating while the particles are agitated by rotating the furnace tube 1 and the rotary kiln is controlled such that the following relationships (1) and (2) hold true:

W/(376.8×R×T²)≦1.0 (1)

(T×R²/0.353)≦3.0≦ (2)

where R is the rotation rate (rpm) of the furnace tube 1, W is the mass (kg/h) of the particles that are put in the furnace tube 1 per hour, and T is the inner diameter (m) of the furnace tube 1.

If the value of W/(376.8×R×T²) on the left side of the relationship (1) is more than 1.0, the inner diameter T and rotation rate R of the furnace tube becomes too small with respect to the mass W of the particles per hour, so the particles become hard to move in the interior of the furnace tube 1, and the bulk of the particles put in the furnace tube 1 becomes high. Accordingly, the carbon coating cannot be formed in a desired amount within a proper time for practical production. In addition, it is difficult to achieve continuous production because the furnace tube 1 is readily blocked. The value of W/(376.8×R×T²) on the left side of the relationship (1) is preferably 0.98 or less, more preferably 0.95 or less to more stably keep continuous production of the negative electrode material.

From the rotation rate R (rpm), the following expression (3) is obtained:

R(rpm)=2πR/60(rad·s⁻¹) (3)

for an angular speed (rad·s⁻¹).

When the time unit of the mass W (kg/h) of the particles put in the furnace tube 1 per hour is changed to second, the mass Ws is expressed by W/3,600 (kg/s). The following expression (4) is defined as:

Ws/ωT² (4)

from the mass Ws (kg/s) per second, the angular speed w (rad·s⁻¹), the inner diameter T (m) of the furnace tube. This expression is rewritten into the following form:

Ws/ωT²=(W/3,600)/((2πR/60)×T²)=W/(376.8×R×T²),

which corresponds to the left side of the expression (1). The value of Ws/ωT² defined as the expression (4) represents the amount of the powder to be put with respect to an area depicted by the diameter rotated, according to its dimension.

The value of T×R²/0.353 on the left side of the relationship (2) is a value defined as Froude number×10⁵. In the invention, this value is controlled to be 3.0 or less.

This expression is obtained as follows. The Froude number Fr defined by the rotation rate of a cylindrical body of rotation and the diameter of the body of rotation is generally expressed by the following expression (5):

Fr=N²T/g (5)

where N is a rotational speed (s⁻¹), T is the diameter of the cylindrical body of rotation (m), and g is the gravitational acceleration (9.8 m/s²).

The rotation rate R (rpm) is converted into a rotational speed expressed as R/60 (s⁻¹). Substituting this in the expression (3) yields Fr=(R/60)²T/9.8=(R²T)/35300. Multiplying this by 10⁵ yields the value on the left side of the expression (2). The Froude number is a parameter correlated with a circumferential speed. The consideration by the inventors revealed that this Froude number determines the behavior of particles put near the inner circumference of the cylindrical body of rotation.

In general, when the particles move in the interior of the furnace tube 1 of the rotary kiln, the particles may slip down on the inner wall of the furnace tube 1 (this mode is referred to as the slip-down mode), or roll down on the inner wall of the furnace tube from above (this mode is referred to as the roll-down mode). In the roll-down mode, the particles are easy to agglomerate to form a small lump. This lump gradually grows while moving in the interior of the furnace tube, and may finally form an agglomeration with a size of 10 to 100 mm. If the value of T×R²/0.353 is more than 3.0, then the circumferential speed by the rotation of the furnace tube 1 becomes very large, and the movement of the particles is easy to enter the roll-down mode, so the above agglomeration is readily generated. The generation of this agglomeration may be a cause to block the furnace tube 1 in continuous production. The difference in the amount of the carbon coating between particles in the agglomeration and particles in a non-agglomeration part causes an uneven amount of the carbon coating in the whole produced particles, leading to reduction in battery characteristics. When the silicon-based negative electrode active material particles of SiOₓ (where 0.5≦x≦1.6) are prepared and each of these particles is coated with the carbon coating while causing these particle to disproportionate in the carbon coating process, the degree of this disproportionation of the particles can be controlled. As the generation of the agglomeration increases, it becomes increasingly difficult to control the disproportionation as intended because of variation in thermal history of the particles.

In view of this, the invention controls the rotary kiln such that the rotation rate R (rpm) of the furnace tube, the mass W (kg/h) of the particles that are put in the furnace tube per hour, and the inner diameter T (m) of the furnace tube satisfy both of the relationships (1) and (2). The invention can thereby form a uniform carbon coating with a desired amount and crystallinity with the same degree of precision as does a conventional batch furnace and mass-produce quality negative electrode active materials by continuous production. Accordingly, a negative electrode active material that enables improvement in the battery capacity and cycle performance can be produced at low cost.

The furnace tube 1 used in the inventive producing method preferably has an inner diameter T ranging from 0.1 m to 3 m. When this inner diameter is 0.1 m or more, a sufficient amount of particles can be introduced into the furnace tube 1, resulting in high productivity. When this inner diameter T is 3 m or less, the interior of the furnace tube 1 can be maintained at a uniform temperature. In particular, the inner diameter T is preferably 2 m or less to maintain a more uniform temperature in the interior of the furnace tube 1. When the inner diameter T is in the above range, the mass W per hour and the rotation rate R are controlled so as to satisfy both of the relationships (1) and (2).

The furnace tube 1 used in the inventive producing method preferably has a length L ranging from 1 m to 20 m. When this length L is 1 m or more, a heating time required for forming the carbon coating can be secured. When this length L is 20 m or less, the distribution of the hydrocarbon-based gas, a carbon source, introduced into the furnace tube can be made more uniform, so a desired amount of carbon coating can be obtained with high precision.

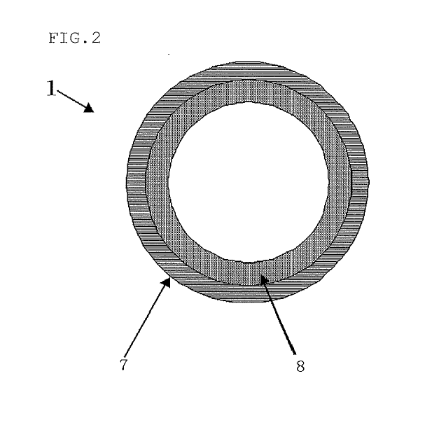

As shown in FIG. 2, the furnace tube 1 used in the inventive producing method preferably has a dual structure composed of an outer metal part 7 and an inner carbon part 8. The reason is that even when the particles agglomerate in the interior of the furnace tube 1 during the carbon coating process, the particles can be inhibited from attaching to the inner wall formed of the inner carbon part 8 as a contact portion with the particles. The carbon may be, but not limited to, cold isostatic pressed graphite, extruded graphite, molded graphite, a carbon composite of carbon fiber and resin such as typically epoxy thermosetting resin, or a composite of carbon fiber and carbon matrix or graphite matrix. The outer metal part 7 inhibits the outer wall of the furnace tube from breaking due to impact. As shown in FIG. 1, the attachment of the particle to the inner wall can be effectively inhibited by providing a vibration unit 6 to vibrate the furnace tube such as an air knocker on the outer wall of the furnace tube 1 and periodically vibrating the furnace tube 1. The outer metal part 7 (the outer wall) is preferable also in this case, for the outer metal part 7 can prevent the furnace tube 1 from breaking even when the air knocker 6 impacts the furnace tube 1. This metal is not particularly limited, and may be selected from stainless steel, Inconel (registered trademark), HASTELLOY (registered trademark), and heat resist cast steel, depending on use conditions such as a temperature.

In the invention, the temperature of the interior of the furnace tube 1 is preferably adjusted to the range from 700° C. to 1,300° C., more preferably from 800° C. to 1,200° C., further preferably from 900° C. to 1,200° C. When the processing temperature is 700° C. or more, the carbon coating process is efficiently performed, and the processing time can be reduced, resulting in better productivity. When the processing temperature is 1,300° C. or less, if the silicon-based negative electrode active material particles of SiOₓ (where 0.5≦x≦1.6) are prepared and each of these particles is coated with the carbon coating while causing these particle to disproportionate in the carbon coating process, the SiOₓ particles can be prevented from excessively disproportioning. In addition, the fusion bonding and agglomeration of each particle can be avoided during the chemical vapor deposition, so a uniform carbon coating with conductivity can be formed. Accordingly, the material provides good cycle performance when used as the negative electrode active material for a lithium-ion secondary battery. If the processing temperature is in the above range, even when the silicon composite powder is coated with carbon, the silicon fine particles are hard to crystallize, so expansion at charging can be inhibited when the material is used as the negative electrode active material for a lithium-ion secondary battery. The term “processing temperature” means the maximum target temperature in the apparatus. For a continuous type of rotary kiln, this processing temperature corresponds to a temperature at the center portion of the furnace tube 1.

It is to be noted that the processing time is determined properly depending on the target carbon coating amount, processing temperature, the concentration (flow rate) and amount of organic gas, and so on; the processing time in the maximum temperature range normally ranges from 1 hour to 10 hours, particularly from 1 hour to 4 hours for the reason of cost efficiency.

The raw material to generate the hydrocarbon-based gas supplied to the interior of the furnace tube 1 in the invention is selected from organic substances capable of generating carbon by pyrolysis at the above heat treatment temperature, particularly under a non-oxidizing atmosphere. Examples of this raw material include hydrocarbon such as methane, ethane, ethylene, acetylene, propane, butane, butene, pentane, isobutane, hexane, and a mixture thereof, and an aromatic hydrocarbon of a monocycle to a tricycle such as benzene, toluene, xylene, styrene, ethylbenzene, diphenylmethane, naphthalene, phenol, cresol, nitrobenzene, chlorobenzene, indene, cumarone, pyridine, anthracene, phenanthrene, and a mixture thereof. A gas light oil obtained by a tar distillation process, a creosote oil, an anthracene oil, a naphtha-cracked tar oil, and a mixture thereof can also be used.

Moreover, an inert gas such as nitrogen or argon may be introduced as a carrier gas together with the hydrocarbon-based gas.

### [Negative Electrode Material for Use in a Non-Aqueous Electrolyte Secondary Battery]

A negative electrode material produced by the inventive producing method will now be described. The amount of the carbon coating of the negative electrode material for a non-aqueous electrolyte secondary battery is not particularly limited; this amount preferably ranges from 1 mass % to 30 mass %, more preferably from 1.5 mass % to 25 mass %, with respect to the total amount of the silicon-based negative electrode active material particle and the carbon coating. The negative electrode material produced by the inventive producing method reliably falls within the above range of the carbon coating amount. When the carbon coating amount is 1 mass % or more, a sufficient conductivity can be maintained, and the material provides good cycle performance when used for a lithium-ion secondary battery. When the carbon coating amount is 30 mass % or less, the ratio of carbon to the negative electrode material can be made proper, and the ratio of silicon-based material can be sufficiently increased, so the material provides high charging and discharging capacities when used for a non-aqueous electrolyte secondary battery.

When the disproportionation is caused to occur in the carbon coating process, the negative electrode material produced by the inventive producing method has a small variation in the thermal history, as described above. Accordingly, adjustment of processing conditions more reliably enables production of a negative electrode material, for a non-aqueous electrolyte secondary battery, having a crystallite size ranging from 1 nm to 10 nm, which is calculated from a half width of a diffraction peak attributable to Si (111) crystal face obtained by X-ray diffraction, as described above.

### [Negative Electrode for Use in a Non-Aqueous Electrolyte Secondary Battery]

The inventive negative electrode for a non-aqueous electrolyte secondary battery includes the negative electrode material for the non-aqueous electrolyte secondary battery, a binder, and a conductive additive. When the negative electrode is produced by using the negative electrode material for a non-aqueous electrolyte secondary battery, the inventive negative electrode material for the non-aqueous electrolyte secondary battery can be used as a main active material. Alternatively, a known graphite-based active material such as natural graphite or synthetic graphite can be used as the main active material and the inventive negative electrode material for the non-aqueous electrolyte secondary battery can be added thereto to form a mix electrode.

Examples of the binder include, but are not limited to, polyacrylic acid, carboxymethyl cellulose, styrene-butadiene rubber, polyvinylidene fluoride, and a mixture thereof.

The conductive additive is not particularly limited; any electronic conductive material that neither decomposes nor transmutes when a battery produced with this material is used suffices for the conductive additive. Specific examples of the conductive additive include powder or fiber of metal such as Al, Ti, Fe, Ni, Cu, Zn, Ag, Sn, and Si, and graphite such as natural graphite, synthetic graphite, various types of coke powder, mesophase carbon, vapor-grown carbon fiber, pitch-based carbon fiber, polyacrylonitrile (PAN) based carbon fiber, and various types of sintered resin.

An example of a method of preparing a negative electrode (a product) is given as follows. The negative electrode material for a non-aqueous electrolyte secondary battery is mixed with a solvent such as N-methylpyrrolidone or water, together with as necessary a conductive additive and other additives such as a binder to form paste-like mixture. This mixture is applied to a sheet current collector. The current collector may be made of a material typically used for a negative electrode current collector, such as copper foil or nickel foil, which can be used without any limitation such as its thickness or surface treatment. It is to be noted that the procedure for forming the paste-like mixture into a sheet is not particularly limited; known methods may be used.

### <Lithium-Ion Secondary Battery>

The inventive lithium-ion secondary battery includes the inventive negative electrode. Other materials for a positive electrode, an electrolyte, a separator, and so on, and the battery shape are not limited in particular; known materials may be used.

### [Positive Electrode]

The positive electrode material is preferably a compound containing lithium. Examples of this compound include a complex oxide composed of lithium and transition metal elements, and a phosphoric acid compound composed of lithium and transition metal elements. Among them, a compound including at least one of nickel, iron, manganese, and cobalt is preferable for the material of the positive electrode. The chemical formula of this compound is expressed by, for example, LiₓM₁O₂ or Li_{y}M₂PO₄, where M₁ and M₂ represent at least one kind of transition metal elements, and x and y represent a value varied depending on a charging or discharging status of a battery, which typically satisfy 0.05≦x≦1.10 and 0.05≦y≦1.10.

Examples of the complex oxide composed of lithium and transition metal elements include a lithium cobalt complex oxide (LiₓCoO₂), a lithium nickel complex oxide (LiₓNiO₂). Examples of the phosphoric acid compound composed of lithium and transition metal elements include a lithium iron phosphoric acid compound (LiFePO₄), a lithium iron manganese phosphoric acid compound (LiFe₁₋ᵤMnᵤPO₄ (0<u<1)). Use of these positive electrode materials enables a higher battery capacity and excellent cycle performance.

### [Electrolyte]

A part of the active material layers of the positive and negative electrodes or the separator is impregnated with a liquid electrolyte (an electrolyte solution). The electrolyte is composed of electrolyte salt dissolved in a solvent and may contain other materials such as additives. The solvent may be, for example, a non-aqueous solvent. Examples of the non-aqueous solvent include ethylene carbonate, propylene carbonate, butylene carbonate, dimethyl carbonate, diethyl carbonate, ethylmethyl carbonate, carbonic acid propylmethyl ester, 1,2-Dimethoxyethane, and tetrahydrofuran. Among these, at least one of ethylene carbonate, propylene carbonate, dimethyl carbonate, diethyl carbonate, and ethylmethyl carbonate is preferably used. The reason is that such solvent enables better battery characteristics.

The combination of a viscous solvent, such as ethylene carbonate or propylene carbonate, and a non-viscous solvent, such as dimethyl carbonate, diethyl carbonate or ethylmethyl carbonate allows much better performances, for such a solvent improves the dissociation of electrolyte salt and ionic mobility.

For an alloyed electrode, the solvent preferably contains a halogenated chain carbonic acid ester, or a halogenated cyclic carbonic acid ester. Such a solvent enables the negative electrode active material to be coated with a stable coating at discharging and particularly charging. The halogenated chain carbonic acid ester is a chain carbonic acid ester including halogen, in which at least one hydrogen atom is replaced by a halogen atom. The halogenated cyclic carbonic acid ester is a cyclic carbonic acid ester including halogen, in which at least one hydrogen atom is replaced by a halogen atom.

The halogen is preferably, but not limited to, fluorine, for fluorine enables the formation of better coating than other halogens do. A larger number of halogens is better, for a more stable coating can be obtained which reduces a decomposition reaction of an electrolyte.

Examples of the halogenated chain carbonic acid ester include carbonic acid fluoromethylmethyl ester, and carbonic acid methyl(difluoromethyl) ester. Examples of the halogenated cyclic carbonic acid ester include 4-fluoro-1,3-dioxolan-2-one or 4,5-difluoro-1,3-dioxolane-2-one.

The solvent preferably contains an unsaturated carbon bond cyclic carbonate as an additive, for this enables the formation of a stable coating on a negative electrode at charging and discharging and the inhibition of a decomposition reaction of an electrolyte. Examples of the unsaturated carbon bond cyclic carbonate include vinylene carbonate and vinyl ethylene carbonate.

In addition, the solvent preferably contains sultone (cyclic sulfonic acid ester) as an additive, for this enables improvement in chemical stability of a battery. Examples of the sultone include propane sultone and propene sultone.

In addition, the solvent preferably contains acid anhydride, for this enables improvement in chemical stability of a battery. The acid anhydride may be, for example, propane disulfonic acid anhydride.

The electrolyte salt may contain, for example, at least one light metal salt such as lithium salt. Examples of the lithium salt include lithium hexafluorophosphate (LiPF₆), and lithium tetrafluoroborate (LiBF₄).

The content of the electrolyte salt is preferably in the range from 0.5 mol/kg to 2.5 mol/kg. The reason is that this content enables high ionic conductivity.

### [Separator]

The separator separates the positive electrode and the negative electrode, prevents short circuit current due to contact of these electrodes, and passes lithium ions therethrough. This separator may be made of, for example, a porous film of synthetic resin or ceramics, or two or more stacked porous films. Examples of the synthetic resin include polytetrafluoroethylene, polypropylene, and polyethylene.

### [Configuration of Laminate Film Secondary Battery]

A laminate film secondary Battery will now be described by way of example of the inventive lithium-ion secondary battery.

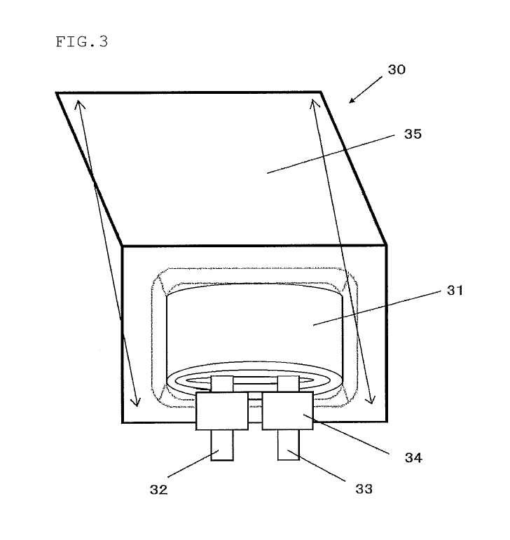

The laminate film secondary battery 30 shown in FIG. 3 includes a wound electrode body 31 interposed between sheet-shaped outer parts 35. The wound electrode body is formed by winding a positive electrode, a negative electrode, and a separator disposed between these electrodes. The electrode body may also be composed of a laminated part of the positive and negative electrodes, and a separator disposed between these electrodes. The electrode bodies of both types have a positive electrode lead 32 attached to the positive electrode and a negative electrode lead 33 attached to the negative electrode. The outermost circumference of the electrode bodies is protected by a protecting tape.

The positive electrode lead and the negative electrode lead, for example, extend from the interior of the outer parts 35 toward the exterior in one direction. The positive electrode lead 32 is made of, for example, a conductive material such as aluminum; the negative electrode lead 33 is made of, for example, a conductive material such as nickel or copper.

An example of the outer part 35 is a laminate film composed of a fusion-bond layer, a metallic layer, and a surface protecting layer stacked in this order. Two laminate films are fusion-bonded or stuck with an adhesive at the outer edge of their fusion-bond layers such that each fusion-bond layer faces the electrode body 31. The fusion-bond layer may be, for example, a film such as a polyethylene or polypropylene film; the metallic layer aluminum foil; the protecting layer nylon.

The space between the outer parts 35 and the positive and negative electrode leads is filled with close adhesion films 34 to prevent air from entering therein. Exemplary materials of the close adhesion films include polyethylene, polypropylene, and polyolefin.

### [Manufacture of Laminate Film Secondary Battery]

Firstly, a positive electrode is produced with the above positive electrode material as follows. A positive electrode mixture is created by mixing the positive electrode material with as necessary a positive electrode binder, a positive electrode conductive additive, and other materials, and dispersed in an organic solvent to form slurry of the positive electrode mixture. This slurry is then applied to a positive electrode current collector with a coating apparatus such as a die coater having a knife roll or a die head, and dried by hot air to obtain a positive electrode active material layer. The positive electrode active material layer is finally compressed with, for example, a roll press. The compression may be performed under heating. The compression and heating may be repeated many times.

A negative electrode active material layer is then formed on a negative electrode current collector to produce a negative electrode through the same procedure as in the above production of the negative electrode for a lithium-ion secondary battery. When the positive electrode and the negative electrode are produced, the active material layers are formed on both faces of the positive and negative electrode current collector. In both the electrodes, the length of these active material layers formed on the faces may differ from one another.

The following steps are then carried out in the order described. An electrolyte is adjusted. With ultrasonic welding, the positive electrode lead is attached to the positive electrode current collector and the negative electrode lead is attached to the negative electrode current collector. The positive and negative electrodes and the separator interposed therebetween are stacked or wound to produce the electrode body and a protecting tape is stuck to the outermost circumference of the body. The electrode body is flattened. The film-shaped outer part is folded in half to interpose the electrode body therebetween. The outer edge of the half parts is stuck to one another by heat sealing such that one of the four sides is opened to enter the electrode body therefrom. The close adhesion films are inserted between the outer part and the positive and negative electrode leads. The above adjusted electrolyte is introduced from the open side in a prescribed amount to perform the impregnation of the electrolyte under a vacuum. The open side is then stuck by vacuum heat sealing.

In this manner, the laminate film secondary battery can be produced. The inventive non-aqueous electrolyte secondary battery, such as the laminate film secondary battery, preferably has a negative electrode utilization factor of 93% to 99% at charging and discharging. The secondary battery having a negative electrode utilization factor of 93% or more prevents reduction in the first charge and discharge efficiency and greatly improves the battery capacity; one having a negative electrode utilization factor of 99% or less prevents the precipitation of lithium, thereby ensuring safety.

### EXAMPLES

The present invention will be more specifically described with reference to examples and comparative examples. However, the present invention is not limited to these examples.

### Examples 1 to 4, and Comparative Examples 1 and 2

With a rotary kiln shown in FIG. 1, each of silicon-based negative electrode active material particles was coated with a carbon coating while the rotation rate R (rpm) of the furnace tube of the rotary kiln, the mass W (kg/h) of the silicon-based negative electrode active material particles that were put in the furnace tube per hour, and the inner diameter T (m) of the furnace tube were controlled as shown in Table 1. During this period, the silicon-based negative electrode active material particles were simultaneously caused to disproportionate. At this time, the length L of the furnace tube was 8.5 m; the temperature of the interior of the furnace tube was 950° C.; the furnace tube was inclined at an angle of 1° with respect to the horizontal plane; methane gas was used as the hydrocarbon-based gas; and argon gas was used as an inert gas. The amount of these gases to be supplied was adjusted properly such that the amount of the carbon coating with which the silicon-based negative electrode active material particles were coated in the negative electrode material for a non-aqueous electrolyte secondary battery that was taken out without agglomerating was 5% on average with respect to the total amount of the silicon-based negative electrode active material particles and the carbon coating.

The silicon-based negative electrode active material particle was a silicon oxide of SiOₓ having an average diameter D₅₀ of 7 μm where x=0.98. This average diameter was a volume average particle diameter by particle size distribution measurement using laser diffractometry.

The values of A and B in table 1 were calculated by the following formulas:

A=W/(376.8×R×T²); B=T×R²/0.353.

These formulas correspond to expressions on the left side of the relationships (1) and (2), respectively.

In this way, each of the silicon-based negative electrode active material particles were coated with the carbon coating. The amount of this carbon coating, with which the silicon-based negative electrode active material particles of the negative electrode material for a non-aqueous electrolyte secondary battery were coated, was then measured. The amount of this carbon coating was measured with a total organic carbon analyzer (made by SHIMADZU CORPORATION). The half width of a diffraction peak attributable to Si (111) centered near 2θ=28.4° was measured on the produced negative electrode active material by X-ray diffraction (Cu-Kα) using copper as a counter negative electrode. The crystallite size of the silicon fine particles (crystals) was calculated by the Scherrer method on the basis of a spread of this diffraction line. The amount of agglomeration was also calculated as follows: part of the produced negative electrode material for a non-aqueous electrolyte secondary battery was sieved with a sieve having 1-mm holes; part of this material that remained on the sieve was regarded as the agglomeration; and the ratio of the mass of this agglomeration to the total mass of the sieved negative electrode material was calculated.

The negative electrode material for a non-aqueous electrolyte secondary battery produced under the above conditions was used to produce electrodes and a battery in the following manner.

### <Fabrication of Electrodes>

N-methylpyrrolidone was added to a mixture of 90 mass % of the negative electrode material produced in examples 1 to 4 and comparative examples 1 and 2, and 10 mass % of polyimide (Rikacoat SN-20 made by New Japan Chemical Co., Ltd.) in terms of solids to form a slurry. This slurry was applied to a surface of 11-μm-thickness copper foil and dried at 100° C. for 30 minutes. The resultant foil was pressed with a roller press to form an electrode. The electrode was dried under a vacuum at 300° C. for 2 hours. The electrode was then die-cut into a 2-cm² circular negative electrode.

Moreover, N-methylpyrrolidone was added to a mixture of 94 mass % of lithium cobalt oxide, 3 mass % of acetylene black, and 3 mass % of polyvinylidene fluoride to form a slurry. This slurry was applied to 16-μm-thickness aluminum foil and dried at 100° C. for 1 hour. The resultant foil was pressed with a roller press to form an electrode. The electrode was dried under a vacuum at 120° C. for 5 hours. The electrode was then die-cut into a 2-cm² circular positive electrode.

### <Fabrication of a Battery of Coin Type>

Next, an evaluation lithium-ion secondary battery of coin type was produced by using the produced positive and negative electrodes, a non-aqueous electrolyte composed of a mixed solution having an ethylene carbonate-to-diethyl carbonate volume ratio of 1:1 and 1 mole/L of LiPF₆ dissolved in the solution, and a 20-μm-thickness separator made of a polyethylene microporous film.

### <Battery Evaluation>

The produced lithium-ion secondary battery of coin type was left at room temperature a night, and then charged and discharged with a secondary battery charging and discharging tester (made by NAGANO K.K). To stabilize the battery, the battery was first charged with a constant current of 0.5 CmA under an atmosphere at 25° C. until the voltage of the test cell reached 4.2V. After this voltage reached 4.2V, the charging was continued while the current was decreased such that the voltage of the test cell kept 4.2V until the current was decreased to about 0.1 CmA. The battery was discharged with a constant current of about 0.5 CmA. When the voltage of the cell reached 2.5V, the discharging was terminated. In this manner, first charging and discharging capacities and first charging and discharging efficiency were obtained. This first efficiency was calculated by the following expression:

First efficiency (%)=(first discharging capacity/first charging capacity)×100.

The cycle performance was investigated in the following manner: First, two cycles of charging and discharging were performed at 25° C. to stabilize the battery and the discharge capacity in the second cycle was measured. Next, the cycle of charging and discharging was repeated until the total number of cycles reached 50 cycles and the discharge capacity was measured every cycle. Finally, a capacity maintenance rate was calculated by dividing the discharge capacity in the 50-th cycle by the discharge capacity in the second cycle. The cycle conditions were as follows: The secondary batteries were charged with a constant current of 2.5 mA/cm² until the voltage reached 4.2V. After this voltage reached 4.2V, the charging was continued while the current density became 0.25 mA/cm² at 4.2V. The batteries were then discharged with a constant current density of 2.5 mA/cm² until the voltage reached 2.5V.

Table 1 shows the summary of the conditions and the results in the examples 1 to 4 and comparative examples 1 and 2.

TABLE 1
L = 8.5 m; temperature of furnace tube interior: 950° C.

| | | | | | | carbon coating | | ratio of | amount of | first | capacity |
|---|---|---|---|---|---|---|---|---|---|---|---|
| | W | R | T | | | amount | crystallite | agglomeration | generated | efficiency | maintenance |
| | (kg/h) | (rpm) | (m) | A | B | (mass %) | size (nm) | (mass %) | agglomeration | (%) | rate (%) |
| example 1 | 10 | 0.3 | 0.5 | 0.35 | 0.13 | 5.1 | 4.3 | 2 | small | 76 | 90 |
| example 2 | 10 | 0.5 | 0.5 | 0.21 | 0.35 | 5.1 | 4.2 | 1 | small | 75 | 91 |
| example 3 | 10 | 1 | 0.5 | 0.11 | 1.41 | 5.3 | 4.0 | 4 | small | 76 | 89 |
| example 4 | 10 | 1 | 1 | 0.026 | 2.83 | 5.0 | 4.1 | 1 | small | 76 | 90 |
| comparative | 10 | 1.2 | 1 | 0.022 | 4.08 | 4.4 | 3.5 | 8 | middle | 72 | 87 |
| example 1 | | | | | | | | | | | |
| comparative | 10 | 3 | 0.5 | 0.035 | 12.7 | 3.6 | 2.2 | 21 | large | — | — |
| example 2 | | | | | | | | | (continuous | | |
| | | | | | | | | | production was | | |
| | | | | | | | | | impossible) | | |

Examples 1 to 4, in which the values of A and B respectively satisfied the relationships (1) and (2), demonstrated that a small amount of agglomeration was generated. The amount of the carbon coating was accordingly about 5%; the difference from the target amount was very much smaller than those in comparative examples. In addition, the variation in the crystallite size of the collected particles was also smaller. In examples 1 to 4, the disproportionation progressed as intended. Thus, because the obtained negative electrode material had the target amount of carbon coating and the target crystallinity, the first efficiency and capacity maintenance rate were better than those in comparative example 1.

Comparative examples 1 and 2, in which the value of B exceeded 3.0, demonstrated that a large amount of agglomeration was generated. The amount of the carbon coating in an agglomerate portion was likely to be smaller than that in a non-agglomerate portion, as described above. When the amount of the carbon coating in the non-agglomerate portion was adjusted to be 5% on average in the production, the amount of the carbon coating after all of the particles coated with the carbon coating, including the agglomerate portion, were mixed was relatively smaller than 5% because a large amount of agglomeration was generated in comparative examples 1 and 2. Accordingly, the first efficiency and the cycle maintenance rate of the second battery in comparative example 1 were worse than those in the examples. In comparative example 2, the furnace tube was blocked because of the large amount of the generated agglomeration, so continuous production was impossible. It is to be noted that the first efficiency and the cycle maintenance rate of the second battery were not measured in comparative example 2.

### Examples 5 to 8, and Comparative Examples 3 and 4

In the same manner as example 1, each of silicon-based negative electrode active material particles was coated with a carbon coating, except that the rotation rate R (rpm) of the furnace tube, the mass W (kg/h) of the silicon-based negative electrode active material particles that were put in the furnace tube per hour, and the inner diameter T (m) of the furnace tube were changed as shown in Table 2 below. At this time, the length L of the furnace tube was 3 m; the temperature of the interior of the furnace tube was 1040° C.

The silicon-based negative electrode active material particle was a silicon oxide of SiOₓ having an average diameter D₅₀ of 4 μm where x=1.01. This average diameter was a volume average particle diameter by particle size distribution measurement using laser diffractometry.

Table 2 shows the summary of the conditions and the results in the examples 5 to 8 and comparative examples 3 and 4.

TABLE 2
L = 3 mi; temperature of furnace tube interior: 1040° C.

| | | | | | | | carbon coating | | ratio of | amount of |
|---|---|---|---|---|---|---|---|---|---|---|
| | W | R | T | | | block of | amount | crystallite | agglomeration | generated |
| | (kg/h) | (rpm) | (m) | A | B | furnace tube | (mass %) | size (nm) | (mass %) | agglomeration |
| example 5 | 1.8 | 0.5 | 0.2 | 0.24 | 0.14 | no | 5.5 | 6.5 | 77 | 92 |
| example 6 | 1.8 | 1.3 | 0.2 | 0.092 | 0.96 | no | 5.4 | 6.0 | 78 | 92 |
| example 7 | 1.8 | 2.0 | 0.2 | 0.06 | 2.27 | no | 5.3 | 5.6 | 77 | 91 |
| example 8 | 2.0 | 1.0 | 0.4 | 0.033 | 1.13 | no | 5.4 | 5.5 | 78 | 92 |
| comparative | 4.0 | 0.2 | 0.2 | 1.33 | 0.023 | yes | 4.3 | 6.3 | — | — |
| example 3 | | | | | | (continuous | | | | |
| | | | | | | production was | | | | |
| | | | | | | impossible) | | | | |
| comparative | 6.0 | 0.35 | 0.2 | 1.14 | 0.07 | yes | 3.2 | 6.1 | — | — |
| example 4 | | | | | | (continuous | | | | |
| | | | | | | production was | | | | |
| | | | | | | impossible) | | | | |

As shown in Table 2, the difference in the amount of the carbon coating from a target amount of 5% in examples 5 to 8 was smaller than that in the comparative examples. In examples 5 to 8, the variation in thermal history of the collected particles was also smaller, and the disproportionation progressed as intended. Thus, because the obtained negative electrode material had the target amount of carbon coating and the target crystallinity, the first efficiency and capacity maintenance rate were as good as examples 1 to 4.

In comparative examples 3 and 4, the value of A exceeded 1.0. In this case, because the inner diameter T and the rotation rate R of the furnace tube were relatively small with respect to the mass W of the particles put in the furnace tube per hour, the particles failed to smoothly move in the furnace tube and the furnace tube was blocked after several days.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

What is claimed is:

1. A method of producing a negative electrode material for a non-aqueous electrolyte secondary battery, comprising:
preparing silicon-based negative electrode active material particles; and
coating each of the prepared particles with a conductive carbon coating that is mainly made of carbon by using a rotary kiln having a rotatable furnace tube to perform chemical vapor deposition using a hydrocarbon-based gas on the particles in an interior of the furnace tube while agitating the particles put in the interior of the furnace tube by rotating the furnace tube and controlling the rotary kiln such that the following relationships (1) and (2) hold true:
W/(376.8×R×T²)≦1.0 (1); and
(T×R²/0.353)≦3.0 (2),
where R is a rotation rate (rpm) of the furnace tube of the rotary kiln, W is a mass (kg/h) of the particles that are put in the furnace tube per hour, and T is an inner diameter (m) of the furnace tube.

2. The method according to claim 1, wherein the inner diameter T (m) of the furnace tube is in a range of 0.1≦T≦3.

3. The method according to claim 1, wherein the furnace tube has a dual structure composed of an outer metal part and an inner carbon part.

4. The method according to claim 2, wherein the furnace tube has a dual structure composed of an outer metal part and an inner carbon part.

5. The method according to claim 1, wherein a length L (m) of the furnace tube is in a range of 1≦L≦20.

6. The method according to claim 2, wherein a length L (m) of the furnace tube is in a range of 1≦L≦20.

7. The method according to claim 3, wherein a length L (m) of the furnace tube is in a range of 1≦L≦20.

8. The method according to claim 4, wherein a length L (m) of the furnace tube is in a range of 1≦L≦20.

9. The method according to claim 1, wherein a temperature of the interior of the furnace tube is adjusted to a range from 700° C. to 1,300° C.

10. The method according to claim 2, wherein a temperature of the interior of the furnace tube is adjusted to a range from 700° C. to 1,300° C.

11. The method according to claim 3, wherein a temperature of the interior of the furnace tube is adjusted to a range from 700° C. to 1,300° C.

12. The method according to claim 4, wherein a temperature of the interior of the furnace tube is adjusted to a range from 700° C. to 1,300° C.

13. The method according to claim 5, wherein a temperature of the interior of the furnace tube is adjusted to a range from 700° C. to 1,300° C.

14. The method according to claim 6, wherein a temperature of the interior of the furnace tube is adjusted to a range from 700° C. to 1,300° C.

15. The method according to claim 7, wherein a temperature of the interior of the furnace tube is adjusted to a range from 700° C. to 1,300° C.

16. The method according to claim 8, wherein a temperature of the interior of the furnace tube is adjusted to a range from 700° C. to 1,300° C.

17. The method according to claim 1, wherein the prepared silicon-based negative electrode active material particles are SiOₓ particles where 0.5≦x≦1.6.

18. A negative electrode material for a non-aqueous electrolyte secondary battery produced by the method according to claim 1, wherein a crystallite size calculated from a half width of a diffraction peak attributable to Si (111) crystal face obtained by X-ray diffraction ranges from 1 nm to 10 nm, and the amount of the carbon coating with which each of the particles is coated ranges from 1 mass % to 30 mass % with respect to a total amount of the particle and the carbon coating.

19. A negative electrode for a non-aqueous electrolyte secondary battery, comprising:
a negative electrode material according to claim 18;
a binder; and
a conductive additive.

20. A lithium-ion secondary battery comprising a negative electrode for a non-aqueous electrolyte secondary battery according to claim 19.
